(19) United States
(12) Patent Application Publication
(10) Pub. No.: US 2007/0116843 A1
(43) Pub. Date: May 24, 2007

(54) Cooked foods containing conjugated linoleic acids

(76) Inventor: David G. Changaris, Louisville, KY (US)

Correspondence Address: MIDDLETON & REUTLINGER, 2500 BROWN & WILLIAMSON TOWER, LOUISVILLE, KY, 40202, US

(21) Appl. No.: 11/286,499

(22) Filed: Nov. 23, 2005

(51) Int. Cl. A21D 10/00

(52) U.S. Cl. 426/549

(57) ABSTRACT

The invention comprises a cooked food comprising an ingredient selected from the group consisting of a prepared conjugated linoleic acid, an ester thereof, a non-toxic salt thereof, diglyceride and triglyceride esters of various isomers of conjugated linoleic acids, conjugated dienes of long-chained fatty acids, and mixtures thereof, said ingredient being present in an amount of at least 3 milligrams per gram of lipid in the food. A portion of the ingredient is present in the food after cooking

### CROSS-REFERENCE TO RELATED APPLICATIONS

This application claims priority under 37 CFR 119(e) to Provisional Patent Application Ser. No. ______ filed on Oct. 3, 2005.

### BACKGROUND

1. Field of the Invention

The present invention relates to cooked foods incorporating conjugated linoleic acids. More particularly, it relates to cooked foods for humans and animals that are made from grain and incorporate conjugated linoleic acids.

2. Description of Related Art

Linoleic acids are polyunsaturated 1 8-carbon fatty acids. Conjugated linoleic acids (CLAs) are a type of linoleic acid having two double-bonded carbon atoms on either side of another carbon atom. CLAs and their derivatives—including esters, non-toxic salts, diglyceride and triglyceride esters of various isomers of conjugated linoleic acids, conjugated dienes of long-chained fatty acids, and mixtures thereof—have been shown to have many beneficial properties when ingested by animals and humans. These benefits include increased metabolic rate, decreased abdominal fat, enhanced muscle growth, lower cholesterol, reduced food-induced allergic reactions, and a generally enhanced overall immune response. In addition, CLAs have also been shown to fight cancer in animal studies.

Unfortunately, CLAs are not extremely stable molecules, and they are well-known to be sensitive to oxidative injury and extreme temperatures. When exposed to air and high temperatures, CLAs denature easily and rapidly, so they have not been incorporated effectively into cooked foods. Consequently, CLAs are typically served as a dietary supplement or as part of a food served as an uncooked mixture.

### SUMMARY OF THE INVENTION

Accordingly, it is an object of the present invention provides a cooked food that contains CLA.

Generally, the invention comprises a cooked food comprising an ingredient selected from the group consisting of a prepared conjugated linoleic acid, an ester thereof, a non-toxic salt thereof, diglyceride and triglyceride esters of various isomers of conjugated linoleic acids, conjugated dienes of long-chained fatty acids, and mixtures thereof, said ingredient being present in an amount of at least 3 milligrams per gram of lipid in the food. A portion of the ingredient is present in the food after cooking.

In one embodiment of the invention, the ingredient also acts as a leavening agent for cooked foods.

### DETAILED DESCRIPTION

While this invention is capable of embodiments in many different forms, the preferred embodiments are shown in the figures and will be herein described in detail. The present disclosure is to be considered an exemplification of the principles of the invention and is not intended to limit the broad aspects of the invention to the embodiments illustrated.

The invention comprises a cooked food containing CLA or its derivatives. Specifically, the ingredient can be selected from the group consisting of prepared conjugated linoleic acid, an ester thereof, a non-toxic salt thereof, diglyceride and triglyceride esters of various isomers of conjugated linoleic acids, conjugated dienes of long-chained fatty acids, and mixtures thereof. The ingredient is incorporated into the food before cooking in the amount of at least three milligrams of ingredient per gram of lipid in the food. Importantly, the CLA exists substantially in the same form before and after cooking and is substantially resistant to the stresses of cooking, including high temperatures and exposure to air. Conjugated linoleic acid is well known to be sensitive to oxidative injury and temperature. In contrast, the cooked food retains a major portion of its biological properties after cooking.

The amount of CLA and its derivatives to be incorporated into a food depends on the specific recipe and the preference of those to be fed. In one embodiment, the cooked food contains milled grains. The amount of CLA to be included in the ingredients of the cooked grain food will vary depending on whether the food is a cookie, a muffin, or a type of bread, for example. The ingredients for making cooked grain foods will generally contain approximately 0.05 to about 5.0% of CLA by weight. The CLA content also can be expressed as the amount of CLA based on the total calories in the ingredients of a serving (e.g., 0.005 to 6 grams CLA per 100 calorie serving). As a further alternative, the amount of CLA can be expressed as a percentage of the lipid of fat in the food ingredients: 0.1 to 100% of the food lipid; or in the amount of CLA per gram of food lipid: 3 to 1000 mg CLA per gram of lipid. However, since CLA and its derivatives have been generally recognized as safe for use as a food ingredient, the amount to be included is not critical as long as enough is present in order for the CLA to be effective.

As previously stated, in one embodiment, the cooked food contains milled grains. Examples of such foods include cookies, muffins, and breads. It is believed that when CLA is cooked into the grain-containing food, the proteins, amino acids, fatty acids and sugars offer some protection to unsaturated fatty acids, such as CLA, despite the high temperatures associated with cooking. Thus, the cooked food retains a portion of its helpful biological properties after cooking.

As an added benefit, the use of CLA and its derivatives in the instant invention improves the texture and palatability of foods made from milled grains. The dough of bread, muffins, cookies, and the like will rise or leaven more when small amounts of an active form of a CLA—such as 9,11-octadecadienoic acid and 10,12-octadecadienoic acid or their derivatives—are added to the dough, which provides superior taste and texture for humans and animals.

While gluten-containing flours benefit from the addition of CLA, CLA has particular benefits for enhancing the taste of non-gluten grains and flours, which have a reputation for being bland and unappetizing. These non-gluten grains include quinoa and arrow root. CLA gives gluten-free cooked foods improved taste and less of a sandy or crumbly texture.

### EXAMPLES

The practice of the present invention is further illustrated by the following examples:

### Example 1

Pancakes

1½ cup all purpose flour

3 tbsp. sugar

¾ teaspoon baking powder (sodium carbonate)

¼ teaspoon salt

1½ cups milk

3 tablespoons unsalted butter

2 eggs

3-cc triglyceride conjugated linoleic acid

The ingredients were mixed thoroughly, left to stand for 10 minutes, and poured in portions onto a hot griddle, resulting in approximately 12 five-inch pancakes

### Example 2

Cake

Butter 1½ cup

Fructose 2 cups

Eggs 5 whole

Vanilla 2 tsp.

CLA diglyceride 1 tsp.

Flour 4-½ cup

Xanthan ¼ tsp

Baking soda

Salt ½ tsp.

Cinnamon 2 tsp.

Dried fruit 4 cups

Ingredients were mixed together and baked at 350 degrees for 10-12 minutes; resulting in one cake.

### Example 3

Muffin Recipe

Apple sauce 4 ounces

Fructose 1 ounce

CLA ½ tsp.

Safflower oil 1½ tablespoon

glycine 1 tablespoon

banana 4 ounces

Flour 1 cup

Xanthan ¼ teaspoon

Salt ¼ teaspoon

The oil, CLA, glycine, applesauce, vanilla, and fructose were creamed together for 5 minutes. The mashed banana was added and folded into the mixture. Next, the dry ingredients were mixed together, and the mixture was baked at 325 degrees for 15 minutes, resulting in 4 large muffins.

### Example 4

Cookies

Butter ½ cup

Fructose ¾ cup

Glycine 1 tsp.

Egg 1

CLA ¼ tsp.

Flour 1⅛ cup

Xanthan ¼ teaspoon

Baking soda ½ teaspoon

Salt ⅛ teaspoon

The butter and fructose were creamed, and the beaten eggs, vanilla, CLA, and glycine were added. All dry ingredients were mixed in, and the cookies were placed in an oven and baked at 350 degrees for 10-12 minutes, resulting in 12 large and 24 small cookies.

In another embodiment of the invention, CLA and its additives also act as a leavening agent and help the cooked foods “rise” in the absence of cooking oil, yeast or other similar baking additives. After being cut in half and stacked for measuring, the pancake having CLA measured 4.1 cm in height. In comparison, the pancake prepared with safflower oil measured only 3.1 cm in height. The following comparative example is illustrative of the ingredient's leavening effect:

### Comparative Example

CLA Pancake

2 mL CLA (diglyceride)

0.5 cup Aunt Jemima® Complete Buttermilk Pancake mix

0.38 cup of water

Ingredients were mixed and fried on a griddle; results in a pancake with a mass of 59.9 grams and a height of 4.1 cm when cut in half and stacked.

Safflower Oil Pancake

2 mL Safflower Oil (Haines Celestial™)

0.5 cup Aunt Jemima® Complete Buttermilk Pancake mix

0.38 cup of water

Ingredients were mixed and fried on a griddle; results in a pancake with a mass of 59.9 g and a height of 3.1 cm when cut in half and stacked.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A cooked food having a plurality of ingredients with a first ingredient incorporated into said food prior to cooking, said first ingredient selected from the group consisting of conjugated linoleic acid, an ester thereof, a non-toxic salt thereof, diglyceride and triglyceride esters of various isomers of conjugated linoleic acids, conjugated dienes of long-chained fatty acids, and mixtures thereof, said first ingredient being present in an amount of more than 0.75% said plurality of ingredients.

2. The cooked food of claim 1 wherein said plurality of ingredients has a substance that preserves at least a substantial portion of double bonds in said ingredient during cooking.

3. The cooked food of claim 2, wherein said substance has a protein extract.

4. The cooked food of claim 2, wherein said substance has a sugar.

5. The cooked food of claim 2, wherein said substance has purified proteins.

6. The cooked food of claim 2, wherein said substance has an amino acid.

7. The cooked food of claim 2, wherein said substance has a peptide.

8. The cooked food of claim 2, wherein said substance has a gluten grain.

9. The cooked food of claim 2, wherein said substance has a non-gluten grain.

10. The cooked food of claim 2, wherein said substance has a fatty acid.

11. A cooked food having a plurality of ingredients with a first ingredient incorporated into said food prior to cooking, said first ingredient selected from the group consisting of conjugated linoleic acid, an ester thereof, a non-toxic salt thereof, diglyceride and triglyceride esters of various isomers of conjugated linoleic acids, conjugated dienes of long-chained fatty acids, and mixtures thereof, said first ingredient being present in an amount of more than 0.75% of said plurality of ingredients; wherein said plurality of ingredients has a milled grain.

12. The cooked food of claim 11, wherein the cooked food is a baked good.

13. A cooked food of claim 11 in which said first ingredient is present in a range of about 0.75 to about 10.0% by weight in said plurality of ingredients.

14. A method of making a cooked food comprising the steps of:
providing a first ingredient selected from the group consisting of conjugated linoleic acid, an ester thereof, a non-toxic salt thereof, diglyceride and triglyceride esters of various isomers of conjugated linoleic acids, conjugated dienes of long-chained fatty acids, and mixtures thereof, said first ingredient being present in an amount of more than 0.75% of a plurality of ingredients making up said cooked food;
adding said first ingredient to other ingredients making up said plurality of ingredients;
mixing said plurality of ingredients; and
cooking said plurality of ingredients.

15. The method of claim 14, wherein plurality of ingredients has a substance that preserves the double bonds in said first ingredient.

16. The method of claim 15, wherein said uncooked food has a protein extract.

17. The method of claim 15, wherein said uncooked food has an amino acid.

18. The method of claim 15, wherein said uncooked food has a gluten grain.

19. The method of claim 15, wherein said plurality of ingredients has a fatty acid.

20. The method of claim 15, wherein said plurality of ingredients has a non-gluten grain.
